(19) United States
(12) Patent Application Publication
(10) Pub. No.: US 2004/0088079 A1
(43) Pub. Date: May 6, 2004

(54) Method and device for obstacle detection and distance measurement by infrared radiation

(76) Inventors: Erwan Lavarec, Montpellier (FR); Laurent Tremel, Castelnau Le Lez (FR)

Correspondence Address: FULBRIGHT & JAWORSKI, LLP, 666 FIFTH AVE, NEW YORK, NY, 10103-3198, US

(21) Appl. No.: 10/470,235

(22) PCT Filed: Jan. 25, 2002
(86) PCT No.: PCT/FR02/00304

(30) Foreign Application Priority Data
Jan. 26, 2001 (FR) 01/01065

(51) Int. Cl. G06F 19/00

(52) U.S. Cl. 700/258; 700/245; 701/301

(57) ABSTRACT

The invention concerns a method for measuring distance between a first object (1) and a second object (2) which consists in: a) emitting an infrared wave radiation (3) from an emitter (4) fixed on the first object (1), said radiation (3) being emitted towards said second object (2); and b) detecting the return of said radiation after it has been reflected by said second object (2) on a receiver (5) fixed on said first object (1) proximate to said emitter (4). The inventive method is characterized in that it consists in: 1/gradually varying the power of the infrared radiation emitted by said emitter (1) until it reaches a detection power (Ps) corresponding to the power of the wave emitted as from which the radiation reflected by said second object is detected by said receiver; and 2/calculating the distance (D) between said first object (1) and said second object (2) from the value of said detection power, by establishing an equating correlation between said distance (D) and said detection power. The invention also concerns a device for detection and distance measurements.

The present invention concerns a measurement of distance between a first object and a second object. The present invention likewise concerns a method for detection of the said second object which may be an obstacle which may be situated in the vicinity of the said first object, in an unknown direction, the said first object being particularly a robot. The present invention likewise concerns a device for detecting an obstacle and measuring the distance between a first object and a second object.

More particularly, the present invention concerns a method for detecting obstacles and for measuring distance without contact, wherein an infrared emitter and an infrared receiver are used.

Different contactless distance measuring systems are known, which can be distinguished either by the type of beam (laser, infrared or ultrasound) or by the technology of the system of measurement (interference, traversal time, beam interruption, triangulation). The principal systems used are the following:

Infrared laser rangefinders contain a source which puts out an infrared laser beam on which the reflected beam is superimposed. The sum of the two signals generates interferences which depend on the distance traversed by the beam. This type of measurement gives an extremely precise measurement of distance and perfectly targets a measurement point. However, this system requires a complex technology the cost of which is great. On the other hand, it requires an optical system which may be fragile.

Ultrasonic rangefinders consist in emitting a sound in the ultrasonic range and measuring the time it takes for this sound to return to the emitter. Since the speed of sound is low in air it is easy to measure precisely the traversal time of the signal. In fact, if an obstacle is present the ultrasonic beam emitted is reflected, and the time it takes for the detector to capture the echo of the ultrasonic wave makes it possible, depending on the medium of propagation, to determine the distance at which it is situated. The absorption of ultrasound in air is great, and increases with the distance it traversess. This is why this technique is used more particularly in much less absorbent aquatic or liquid media in order to visualize marine bottoms (sonar) or also in medical imagery (echography). Furthermore, this ultrasonic method is not very directional. It greatly depends on the support and can be disturbed by currents (air or water). On the other hand, it can give erroneous information on smooth surfaces since there is a total reflection of the wave in a single direction (mirror effect). This type of detector is available from the manufacturer, MURATA®, under reference MA40.

Also known are remote detection and measurement methods based on infrared radiation. Among the various techniques involving infrared radiation, several types of methods are distinguished:

a first type is based on the classical principle of triangulation and is very widely used in commercial detectors,

a second type is based on the measurement of a phase shift between emitted signals and received signals, and

a final type involves measuring the traversal time of an infrared laser ray; this last system, although very precise, is very complex and costly.

A distance measuring system using infrared triangulation is sold, especially by the firm LYNXMOTION under the name of IRPD® (Infrared Proximity Detector). It is principally made up of two electroluminescent diodes emitting infrared rays, and an infrared receiver (GPIU58Y) and a microcontroller permitting the successive feeding of two electroluminescent diodes which monitor the reflection. Detection is asynchronous, the two diodes operate alternately. The two electroluminescent diodes are modulated by a controllable oscillator. The sensitivity of the detector contains filters which make it sensitive to an infrared ray modulated at 38 KHz, thus making it possible to minimize the effect of disturbances due to the ambient medium, such as natural light. The chief problem of this system lies in its short range. In fact, it is unable to detect an obstacle situated at a distance of from 15 to 30 cm.

Other systems called DIRRS® (Distance Infrared Ranging System marketed by HVW Technologies) and IRODS® (Infrared Object Detection System, also marketed by HVW Technologies) which are among the best performers and utilize the principle of synchronous triangulation. The system is made possible by using a PSD (Position Sensitive Detector) receiver and an optical lens which focuses the reflected IR signal. The PSD is a system that is able to modify its output signal level according to the position at which the rays strike it. The major difference between these two devices is only in the level of their output signal, the one being analog (IRODS) and the other digital (DIRRS). These detectors show not only the presence or absence of an object in front of the detector, but they can also indicate the distance at which a potential obstacle is situated: either by a voltage (IRODS) or by a code number of 8 bits (DIRRS). It permits reliable measurements of distances only between 10 and 80 cm. These two systems operate by means of the SHARP GP2DO2® for the DIRRS® and the SHARP GP2DO5® for the IRODS® detector.

Other systems are based on the phase shift of the signals. These devices permit proximity detection. They are composed of several light-emitting diodes affixed to the top of small infrared receivers and arranged around, for example, a robot. When one of the light-emitting diodes emits an infrared ray which is reflected by any object situated opposite it, it is the intensity of the reflected infrared ray that is detected by the receiver and which is translated by a proportional analog voltage. The distance separating the object from the receiver is determined by measuring the phase difference between the signals emitted and received. The receivers used are generally SHARP® (GP1U52X or GPU58X)® which are sensitive to wavelengths of the order of 38 KHz.

The main differences between the different systems are on the one hand in the arrangement of the emitting diodes around the robot, and on the other hand in taking into account the possible interferences between the different radiations emitted. One receiver can detect the reflected ray coming from an emitter other than the one with which it is associated. Any evaluation of the direction of the object by its distance is then falsified.

In devices based on methods taking account of the phase shift of the signals, interferences conflict with distance measurements, whereas in triangulation they contribute toward increasing the precision of measurement.

It is one object of the present invention to provide a distance measuring or object detection system that could be easily mounted on a small domestic robot and that might therefore be sufficiently light and compact to be carried by robots of small dimensions without affecting their mobility.

Another object is to provide at the lowest possible cost a high-performance object distance detection and measuring system, and in particular to provide a system whose field of detection can be particularly on the order of 0 to better than 10 m, with a resolution on the order of one centimeter.

Another object is to achieve a detection and measurement device whose outputs will be digital and able to be connected to a parallel port and controlled from a command processor of a robot.

From a first point of view, the invention concerns distance detection and measurement between a first object and a second object; the said process being such as to include the following steps:

a) The step of emitting an infrared radiation from an emitter affixed onto the said first object and fed by an electrical emission signal, and

b) the step of detecting the return of the said infrared radiation to a receiver, after the said infrared radiation has been reflected by the said second object,

the said receiver being affixed onto the said first object close to the said emitter and producing an electrical signal of reception.

the said process being characterized in that it furthermore includes the following steps:

the step of gradually varying the power of the infrared radiation emitted by the said emitter, while controlling the said electrical signal emitted, until the power of the emitted infrared radiation reaches such a detection power (DP) that, for this detection power (DP), the infrared radiation is detected by the said receiver after its reflection from the said second object,

the step of calculating the distance (D) between the said first object and the said second object from the value of the said detection power (DP), establishing a correlation, particularly by calibration, between the said distance (D) and the said detection power.

This process is generally used in air for detecting objects of solid material. But it is also appropriate for any space that is permeable to infrared. The physical principle utilized therefore consists in emitting a power-modulated infrared signal and measuring the energy received by reflection. Since the energy decreases with the distance traversed, the power of the wave emitted by the source is increased until an echo detectable by the receiver is obtained. One originality of this principle therefore consists in taking advantage of the fact that if the power of the wave emitted (which is generally connected with the amplitude of a command signal from the emitter) is insufficient, considering the distance to be traversed to the obstacle, the reflected wave is not detected by the receiver; the distance is therefore measured by detecting the return of the echo signal produced by an obstacle and by having the emitter emit radiations whose power gradually increases until the receiver detects a signal. If the system still has not detected anything when the full emission power is reached, this signifies that there is no obstacle in the direction explored, at a given distance considered as significant. On the other hand, if the receiver receives and detects an echo, it is preferable to verify that this echo is indeed that of the emitted signal.

The term, “receiver,” used herein is understood to mean a device which emits an electrical signal when it receives an infrared radiation of sufficient intensity. In general, these infrared receivers are composed of phototransistors or photodiodes, and operate on the principle of converting an infrared radiation to an electrical voltage.

Preferably, in a process according to the invention:

a) an infrared radiation is emitted with a specific wavelength, preferably between 850 nm and 950 nm, by means of an emitter containing (and/or consisting of) an electroluminescent diode, and

b) a receiver is used which contains (and/or is constituted by) a phototransistor or photodiode which specifically detects the said wavelength.

Preferably, in order to distinguish the emission source from other sources which emit on the same wavelength, a receiver is used which specifically detects an infrared wave emitted in a pulsed manner at a given specific pulse frequency (still called, “carrier frequency”), and the said pulsed mode of the infrared wave emitted is generated from a discontinuous electrical power supply to the said emitter, in the form of a square wave signal.

Indeed, traditionally there are available on the market specific receivers for an electromagnetic wave emitted in a pulsed manner at a given pulse frequency, the said receivers being characterized by their two-fold specificity as regards the wavelength of the infrared wave, and as regards the carrier frequency of the electrical power supply, that carrier frequency is traditionally from 30 to 60 kHz, particularly 38 kHz. Thus, there is no need to use a specific receiver for the electrical mains frequency, which is 50 or 60 Hz.

To generate the electrical power for the said emitter with a square wave, the said emitter is generally coupled to a transistor.

More precisely, according to an advantageous embodiment, steps are performed in which:

a) the said infrared radiation is emitted in a mode offering a given pulse frequency, and

b) the reflected wave received by the said receiver is detected only if it has the same pulse frequency.

The power supplied to the diode emitting in a pulsed mode makes it possible to increase its range considerably. Indeed, to the degree that the wave is emitted for a short time, the power of the wave emitted can become increased. In fact, infrared diodes cannot operate at high power for more than a few instants and they briefly withstand overloads. Thus objects at a great distance from the pickup can be detected.

Furthermore, this emission of infrared waves in a pulsed mode makes it possible to avoid saturating the space surrounding the infrared radiation, thus enabling other systems to make measurements without interfering with one another.

To further increase the specificity of the device, particularly when other devices of the same type are operating near the emitters that are issuing waves on the same carrier frequency, a digital signature (or code) is inserted into the electrical signal supplying the said emitter, so that the infrared radiation put out by an emitter includes its identifying signature. This digital signature of a given number of bits, particularly at least 4 bits, can be superimposed upon (and/or be associated with) the said pulse frequency.

If the receiver receives a signal of the same signature as the signal emitted, this signifies that an obstacle is detected. The pickup-to-obstacle distance is then deduced from the emission power and possibly from the sensitivity which it has had to develop to detect the signal. If the signature of the detected signal is different, then the received signal comes from another source and it is concluded that no obstacle has been detected.

Thus, in an advantageous embodiment of the method of the invention,

the said emitter and the said receiver include or are coupled to transistors, so that a logical “0” or “1” electrical signal is given according to whether a wave has or has not been emitted by the emitter, and according to whether a wave is detected or not detected by the said receiver,

the said mode of pulsation of the pulsed infrared wave is generated by an electrical power supply of the said emitter producing a square-wave electrical signal, particularly at a given frequency of pulsation or carrier frequency of 38 kHz, the said electrical signal fed to the said emitter containing the said digital signature, and

a check is made as to whether the electrical signature of the power supplied by the said receiver contains the same digital signature as the electrical signal fed to the said emitter by comparing the electrical signals delivered to the emitter and those supplied substantially simultaneously by the said receiver.

Thus, an electronic circuit connected to the emitter(s) and receivers (s) begins to emit an infrared signal which it seeks to detect at the same instant. Since the maximum distances to be measured are on the order of 10 m, another innovative and advantageous point of the method of the present invention lies in the hypothesis according to which the traversal time of the infrared wave within such distances is negligible (since the wave velocity in a round trip of 10 m is 68 ns).

In one embodiment of the process of the present invention,

a) rays of variable powers are emitted containing 2ⁿ different radiation power levels from n resistances of different values controlled by field-effect transistors, making it possible to supply the emitter with a current of increasing intensity containing n² different increasing values, which are adjusted by the logical commands of these transistors, such that the progressive variation of the power emitted results from the control of the transistors by a coded digital signal on n bits corresponding to the n logical commands of the n transistors, and

b) the distance D between the first object and the second object is determined among 2ⁿ values of distances previously determined by calibration, according to the digital signal (recorded in a memory of the system performing the measurement) corresponding to the said detection power.

More particularly, a diode emitter capable of emitting a given maximum radiation power P1 is used, and a receiving diode capable of detecting a given minimum radiation power P2, the values of P1 and P2 being such that distances can be measured between 0.5 m and 5 m, and preferably even between 0.1 m and 10 m, particularly with P1 varying from 250 to 500 mw/Sr and P2 varying from 0.1 to 10 mw/Sr (milliwatts per steradian).

More particularly, the following emitters and receivers can be used:

Emitters:

| Reference | Manufacturer | Power* (mW/Sr) |
|---|---|---|
| LD274 | Siemens | 350 |
| SFH4391 | Siemens | 280 |
| SFH4500 | Siemens | 500 |

*Emission of 100 μs with a current of 1A

Receivers:

| Reference | Manufacturer | Sensitivity (mW/Sr) |
|---|---|---|
| TSOP1838 | Temic | 0.3 |
| SFHS5110 | Infineon | 0.35 |

Preferably, a number of pulses of increasing power are emitted and, depending on the case, a number n of resistances of different Ri values with I=1 to n, such that the precision of measurement, consisting in the separation between the said 2ⁿ possible consecutive distances, is a precision of at least 10 cm, preferably of at least 1 cm.

The number n of said Ri resistances determines the sensitivity of the measurement of the obstacle.

According to one embodiment of the process for determining the position of one or more second objects in relation to a reference system connected with the said first object; the process furthermore includes the following step:

The step of emitting infrared rays from the said first object, in several directions distributed appropriately around the said first object, preferably in at least four directions, and more preferably in at least eight directions;

the said infrared rays, associated with each direction, being emitted in cones whose apex angle is between 5 and 90°,

such that the said second objects situated in the environment of the said first object are detected and their position with respect to a reference system connected with the first object can be computed.

The present invention also has as its subject a device for the detection and measurement of the distance between a first object and a second object, the said device furthermore containing:

an infrared radiation emitter affixed to the said first object and fed with an electrical emission signal,

a receiver detecting the return of the said infrared ray after the said infrared ray has been reflected by the said second object;

the said receiver being affixed to the said first object close to the said emitter and producing an electric signal indicating reception;

the said device containing:

means for controlling the said electric signal indicating emission, making it possible to gradually vary the infrared radiation power emitted by the said emitter, controlling the said electrical emission signal until the power of the infrared radiation emitted attains a detection power (DP) such that, for this detection power (DP), the infrared radiation is detected by the said receiver after reflection by the said second object,

means for computing the distance (D) between the said first object and said second object from the value of the said detection power (DP), using correlations previously established especially by calibration between the said distance (d) and the said detection power (DP).

More particularly, a device according to the invention includes:

an emitter containing an electroluminescent diode which emits specifically at a given infrared wavelength,

a receiver containing a phototransistor which specifically detects the said given infrared wavelength, and preferably specifically a wave that is pulsed at a said given pulse frequency.

According to the preferred embodiments of the device:

the said means for controlling the said electrical signal make it possible to vary gradually the power of the infrared radiation emitted by the said emitter, including a first processor controlling the said electrical emission signal, such that the said infrared radiation is emitted according to a specific mode including a signature;

the said first processor is programmed such that the specific mode of emission of the said emitter is a pulsed emission mode having a given pulse frequency characterizing the said signature;

the said first processor controlling the said electrical emission signal is programmed such that the specific mode of emission of the said emitter is a pulsed mode of emission containing a digital signature;

the said first processor is programmed such that the specific mode of emission of the emitter is a pulsed mode of emission having a given pulse frequency characterizing the said signature;

the said first processor controlling the said electrical emission signal is programmed such that the specific mode of emission of the said emitter is a pulsed mode of emission containing a digital signature;

the said first processor is programmed such that the said electrical emission signal is a square-wave signal and that the said digital signature of the said infrared radiation appears in the form of a logical signal composed of (“1”) or (“0”) according to whether the emitter is or is not fed by the said square-wave signal;

to determine whether a reflected infrared ray received by a receiver from a particular object originates from an emitter situated on the said determinate object, the said first processor includes means for verification of the said signature, so that it is possible to discriminate between the reflected infrared radiation coming from the emitter on the said determinate object and the infrared rays coming directly or indirectly from other objects;

the means for the verification of the said signature include means for comparing the electrical signal feeding the emitter from the said determinate object with the electrical signal given by the receiver from the same said determinate object.

the said first processor, particularly a microcontroller, and a second processor or external processor are connected to one another, to the said emitter and to the said receiver such that:

by a digital signal on n bits, the said first processor controls, through field effect transistors, n resistances of different values installed in the electric power supply circuit of the said emitter, such that the infrared radiation power emitted by the said emitter, particularly by an electroluminescent diode, can assume 2ⁿ increasing values,

the said first processor, connected to the receiver, verifies that the electrical signal supplied by the receiver contains the same signature, particularly the said digital signature,

the said first processor transmits to a second processor a signal formed of n bits indicating, from among the 2ⁿ possible values of the said detection power (DP), the one which has been verified,

the said second processor computes the distance between the first object and the second object by correlation from a calibration of the 2ⁿ possible distance values in relation to the 2ⁿ values of detection power.

The method and device according to the present invention can be used in any application requiring distance measurement, such as:

measuring distance between motor vehicles for driving safety,

measuring the fill level in a vessel,

counting objects in a production line.

The present invention likewise relates to a method and apparatus for detection of a second object which might be situated in the vicinity of a first object in an unknown direction, characterized in that a plurality of measurements are made with a plurality of pickups, each pickup containing a combined emitter and receiver, the emitter and the receiver being fixed with respect to one another, by a process of distance measurement according the invention as defined above, the said emitters being arranged so as to emit the said rays in several directions, preferably at least four directions, more preferably at least eight, in the space around the said first object, and the said emitters emitting rays in a direction in space defining a cone whose apex coincides with said emitter, and whose angle at the apex is between 5 and 90°, so that the said second objects situated in the vicinity of the said first object are detected and their positions can be computed in relation to a frame of reference connected to the first object.

The present invention likewise relates to an obstacle detection and distance measuring device containing a plurality of emitter-receiver units affixed to the said first object and arranged as defined above, the said emitter-receiver units being connected to a said first processor and a said second processor.

From another point of view, the invention provides a mobile robot which can detect and avoid obstacles; the mobile robot includes means of movement controlled by a means containing a device for the detection and calculation of distance as defined above, so that:

if one or more obstacles are in the vicinity of the said mobile robot,

and the said mobile robot moves in a direction coinciding with the one in which the said obstacle is situated,

if the distance measured between the said mobile robot and the said obstacle is less than a value determined particularly in relation to the speed of movement of the said mobile robot,

the said device schedules a change of route making allowance for any other obstacles situated in the vicinity.

The present invention also relates to a process of detection and avoidance of an obstacle by a body in motion, especially a robot, characterized in that it includes a process of measurement according to the invention as defined above, wherein:

the said body in motion corresponds to the said first object,

the said obstacle corresponds to the second object, and

a modification of the course of the said body in motion, particularly a robot, is commanded, if the measured distance is less than a given value, particularly a value below which the said obstacle cannot be avoided, considering the velocity of movement of the said body in motion.

The present invention likewise relates to a body in motion, particularly a robot equipped with an obstacle detection and distance measuring apparatus pursuant to the invention.

Other characteristics and advantages of the present invention will appear in the light of the detailed embodiments that follow.

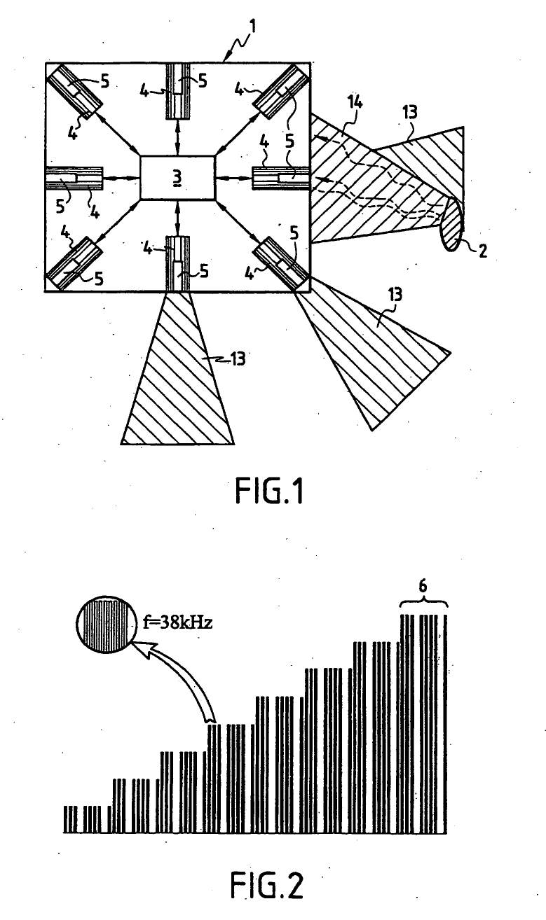

FIG. 1 is a schematic view of a mobile robot according to the invention, equipped with eight obstacle detecting infrared pickups.

FIG. 2 is a portion of a chronogram showing the increase schematically by eight “hatched” bars representing current delivered to an emitter diode according to the invention; this chronogram may correspond to one period of the periodical variation of this current (in the case of a command signal coded in 3 bits), or else to a portion of this cycle (for example, one half-cycle).

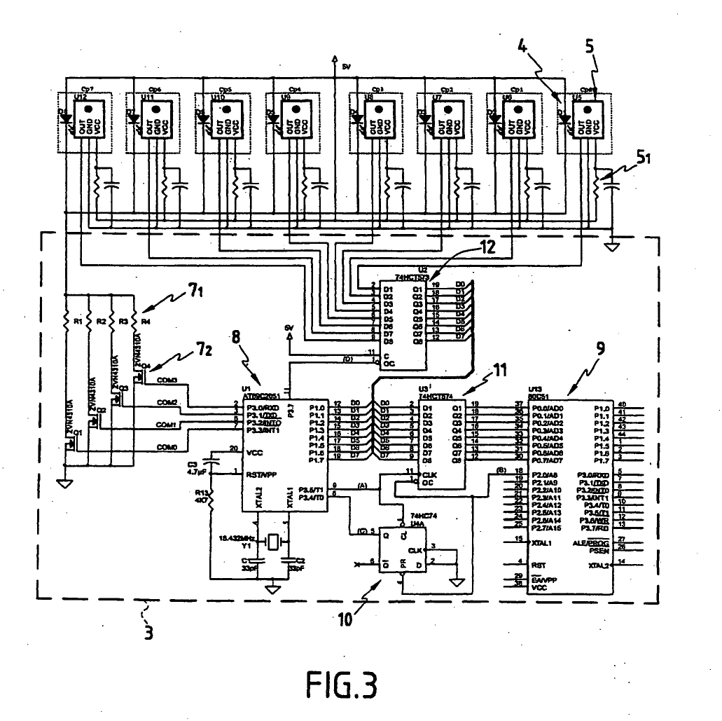

FIG. 3 is a schematic diagram outlining the structure of an electronic circuit (ref. 3, FIG. 1) for the analysis, control and treatment of signals exchanged by the infrared emitter-receivers.

FIG. 1 is a schematic diagram of the installation with eight pickups on a body in motion such as a robot 1, distributed among eight directions in space, showing the cones 13 of the rays emitted and the rays 14 reflected by obstacles 2 back to the receiver 5.

FIG. 2 represents 8 (of 16) levels of electrical current in the emitter diode, and thus 8 (of 16) power levels of the wave emitted by an emitter diode, corresponding to a digital signature of 10 bits, “1110110111101,” the wave being emitted in a pulsed mode at 38 kHz.

FIG. 3 represents a schematic diagram of an electronic assembly representing the eight emitter diodes 4 (D1 to D8) connected to a microcontroller 8, the eight receivers 5 (U5 to U12) and an external processor 9 (U13). Communication between the processors 8 and 9 is carried on through the medium of a flip-flop type register 11 (U3) with an open collector output.

A distance measuring system has been made containing eight pickups (Cp₀ to Cp₇) consisting therefore in a set of 8 emitters 4 and 8 receivers 5, each of the pickups being mounted on a robot 1. Each receiver 5 is mounted on top of the corresponding emitter 4. The emitters 4 are arranged so as to emit infrared rays in 8 directions regularly distributed in the space around the said first object; each of the emitters emits radiation in a direction in space defining a cone 13 whose apex coincides with the said emitter and whose angle at the apex is 20°.

This system is useful for the detection and avoidance of obstacles by the robot 1 forming the said first object. Depending upon the detection and measurement of the distance from an obstacle, a change in general is made in the course of the robot if the distance measured is less than a given value.

Each emitter 4 (D1 to D8) is constituted by an infrared ray electroluminescent diode, commercial name SIEMENS® LD274; each receiver 5 (U5 to U12) is a high-gain phototransistor, commercial reference TEMIC® TSOP 1838®. The characteristics of the emitter diode LD274 are: angle of emission θ=20°, current I=100 mA, wavelength λ=950 nm, irradiance W=35 mW/Sr. The characteristics of the receiver are: angle of reception θ=90°, wavelength λ=950 nm, irradiance W=0.3 mW/Sr, carrier frequency f=38 kHz.

To each of the emitter diodes the same electric current is simultaneously applied, producing the same infrared radiation.

A microcontroller 8 (U1) and an external processor 9 (U13) are connected to one another via the register (U3) 11. The interface between the microcontroller 8 and the external processor (9) is synchronized by register 10 (U4). Lastly, the microcontroller 8 directly pilots the eight emitters 4 and analyzes the data delivered by the eight receivers 5 through the register (U12).

The references of the components used are the following:

| Reference | Designation | Function | Manufacturer |
|---|---|---|---|
| U1 | AT89C2051 | Microcontroller | Atmel ® |
| U2 | 74HCT573 | Register CO* | Philips ® |
| U3 | 74HCT574 | Register CO* | Philips ® |
| U4 | 74HCT74 | Flip-flop R/S | Philips ® |
| U13 | 80C51 | Processor | Philips ® |
| Q1 to Q4 | ZVN4310A | Transistor | Zetex ® |
| U5 to U12 | TSOP1838 | IR detector | Temec ® |
| D1 to D8 | LD274 | IR diode | Siemens ® |

*Open collector

Control of the emission of the infrared diodes is performed in a pulse mode by the microcontroller 8 which supplies a square wave signal, at a carrier frequency of 38 kHz which is amplitude modulated so as, on the one hand to define the digital signature associated with each emitter, and on the other hand to control the level of emission of the diodes; the emission level of the diodes corresponding to the height of the steps (FIG. 2) varies with the state of the transistors Q1 to Q4; for each column the signal fed to the diodes contains a digital signature formatted here on 10 bits equaling “1110111101” as represented diagrammatically in FIG. 2: to each bit of value “1” corresponds a train of nine pulses of the carrier frequency, the total length of which is in this example equal to about 237 microseconds; to each bit of value “0” corresponds an interruption of the power to the diode for the same length of time.

The schematic representation of the digital signature in FIG. 2 shows that, if each column is divided into ten units of time, the electric power (pulsed at a frequency of 38 kHz) is interrupted at the fourth and at the ninth unit of time.

Verification of the digital signature 6 is achieved by the microcontroller 8, which compares the electrical signals sent to the emitter 4 with those supplied substantially simultaneously by the corresponding receiver 5 through the medium of register 12.

Each receiver 5 includes a transistor (not shown) and provides a logical 1 or 0 signal according to whether or not a wave pulsed at the said carrier frequency is detected by the said receiver 5, that is to say, according to whether or not a wave is emitted from the said emitter and then reflected by a said obstacle.

Each emitter 4 is coupled to a transistor 72 as explained below and it is controlled by a logical 1 or 0 signal, so that a pulsed infrared ray is emitted or not, according to whether a wave pulsed at the said carrier frequency is emitted or not.

The assembly 71, 72, having four branches in parallel and inserted into the power supply common to the eight emitting diodes, enables the generation of 16 levels (or steps) of current in the eight emitting diodes 4 (D1 to D8); each branch contains a resistance (R1 to R4) connected in series with an FET transistor (Q1 to Q4).

With such a set-up, each diode is made to emit beams of variable power containing sixteen (2⁴) different values (or steps) of radiation power from four resistors 71 of different values (R1 and R4) controlled by the transistors 72 (Q1 to Q4), which make it possible to provide current of increasing intensity including sixteen different values increasing in accordance with the logical commands of said transistors (COM 0 to COM 3). Each of the said power levels emitted corresponds to a digital signal of 4 bits, corresponding to the four logical controls of the said four resistors. A preliminary calibration between the corresponding distance and each of the sixteen possible detection powers has been performed, so that the external processor 9 can determine the distance D between the robot and any obstacle from among the sixteen values of possible control distances of the transistors Q1 to Q4 (which is supplied cyclically by the processor 8 and transmitted to processor 9), according to the digital signal corresponding to the said detection power. Thus, depending on the logical commands (0 or 5 volts) of the four commands COM 0 to COM 3 of R1 to R4, a more or less large current is set in the infrared emitter diodes D1 to D8, and hence an infrared beam of increasing power, whose timing is similar to that represented in FIG. 2, is generated simultaneously and for each diode.

The control of the four resistors 7 is performed by the transistors 7₂, the polarization of which is made directly at 5 volts. Here there are 4 controls, or a search on 16 zones or steps of power. The resistors are selected at different values and in multiples of 2. Thus, the current in one resistance is twice that of the one following. The current common to the emitting diodes is as shown in FIG. 2, with a signature coded, for example, on ten bits (here, 1110111101).

The detection of the return infrared signal is performed with a receiver 5 containing an integrated circuit providing as output a logical signal of 0 or 5 volts when it receives or does not receive an IR radiation of 950 nm pulsed at a frequency of 38 KHz. For these receivers the receiver power supply must be filtered with filters 5₁ (containing a condenser of 10 μF and a resistance of 330 Ω), because slight variations in its power supply can result in false detections.

After a calibration in which a correlation has been established between the power emitted and the pickup-to-obstacle distance, it is possible to have a numerical measure of distance according to the response obtained.

Table 1 below shows by way of example the measurements performed on a white roughcast wall as the obstacle, with the following resistance values: R1=15 Ω. R2=35 Ω, R3=68 Ω, R4=150 Ω.

TABLE 1

| Distance (cm) | Power Index |
|---|---|
| 30 | 1 |
| 75 | 2 |
| 90 | 3 |
| 108 | 4 |
| 120 | 5 |
| 140 | 6 |
| 165 | 7 |
| 195 | 8 |
| 210 | 9 |
| 225 | 10 |
| 255 | 11 |
| 270 | 12 |
| 300 | 13 |
| 315 | 14 |
| 380 | 15 |
| 450 | 16 |

The electronic circuit that permits handling the communication and transmission of the measurement made by the eight pickups is represented in FIG. 3.

The circuit represented in this FIG. 3 enables the transmission of eight measurements corresponding respectively to the eight pickups, each giving data in 8 bits. For this purpose a coding us mixing at once the measurement of the pickup on 4 bits (the sixteen purpose a coding us used coded on 4 bits) and the identification of the associated receiver, which is likewise coded on 4 bits).

The mode of transmission of the measurement must be parallel, because here an 8-bit bus is used on the external processor 9. Since it is impossible to bring up the amount of data corresponding to the 8 measurements all at once on the 8-bit bus, the measures are simplified by bringing them up one by one. So, for an acquisition sequence giving 8 distinct measurements, 8 reads are needed by the external processor 9 to acquire these data.

The interface between the microcontroller 8 (U1) and the external processor 9 (U13) is accomplished by a register 11 (U3) of the flip-flop type with an open collector output, the loading (or writing of the measurements) is done by the microcontroller 8 and the entry (or reading of the measurements) is performed by the external processor which then computes the distance corresponding to an obstacle.

The microcontroller 8 is then informed that the external processor 9 has performed a reading, by reading the value of the flip-flop (set/reset) on register 10 (U4). The flip-flop is then reinitialized when the microcontroller enters a new measurement value into the register. When a transmission to the processor has begun, the measuring phase is stopped. When the external processor is busy, the microcontroller returns to distance measurement.

1. Method for the detection and measurement of the distance between a first object (1) and a second object (2), the said method being such that it includes the following steps:
a) The step of emitting an infrared radiation (3) from an emitter (4) affixed to the said first object (1) and fed by an electric emission signal, and
b) the step of detecting the return of the said infrared radiation to a receiver (5), after the said infrared radiation has been reflected by the said second object (2);
the said receiver (5) being affixed to the said first object (1) close to the said emitter (4) and producing an electrical signal of reception;
the said process being characterized in that it furthermore includes the following steps:
c) the step of gradually varying the infrared radiation power emitted by the said emitter (4) by controlling the said electrical emission signal, until the power of the infrared radiation emitted attains a detection power (PS) such that, for this detection power (PS) the infrared radiation is detected by the said receiver (5) after reflection by the second object,
d) the step of calculating the distance (D) between the said first object (1) and the said second object (2) starting out from the value of the said detection power (PS), by establishing a correlation, particularly by calibration, between the said distance (D) and the said detection power.

2. Method according to claim 1, the said method being such that the said infrared radiation is emitted in a specific mode containing a signature characteristic of the said emitter (4).

3. Method according to claim 2, the said method being such that the said signature is characterized by the specific mode of emission of the said emitter (4), particularly by a mode of pulsed emission having a given pulsation frequency.

4. Method according to either one of claims 2 or 3, the said method being such that the said signature is a digital signature, particularly a digital signature associated with a pulsed mode of emission.

5. Method according to claim 4, the said electrical emission signal being a square-wave signal, the said method being such that the digital signature of the said infrared radiation appears in the form of a logical signal composed of (“1”) or of (“0”) according to whether the emitter is or is not fed by the said square-wave signal.

6. Method according to any one of claims 2 to 5, the said method being such that to determine whether a reflected infrared radiation received by a receiver (5) from a particular object (1) originates from an emitter (4) situate on the said determinate object, the said signature is verified such that it is possible to discriminate between the reflected-infrared radiation coming from the emitter (4) on the said determinate object (1) and the infrared rays coming directly or indirectly from other objects.

7. Method according to claim 6, the-said method being such that, to verify the said digital signature, the electrical signal powering the emitter (4) of the said determinate object (1) is compared with the electrical signal provided by the receiver (5) on the same said determinate object (1).

8. Method according to any one of claims 1 to 7, the said method being furthermore more particularly designed to determine the position of one or more second objects (2) in relation to a frame of reference bound to the said first object (1), the said method furthermore containing the following step:
the step of emitting from the said first object (1) infrared rays in several directions appropriately distributed about the said first object, preferably in at least four directions, preferably also in at least three directions,
the said infrared rays associated with each direction being emitted in cones whose apex angle is between 5 and 90°,
such that the said second objects (2) situated in the vicinity of the said first object (1) are detected and that their positions in relation to a frame of reference tied to the first object (1) can be calculated.

9. Method for detection and measurement of distance between a first object (1) and a second object (2), the said device containing:
an emitter (4) of infrared radiation affixed to the said first object (1) and supplied with an electrical emission signal,
a receiver (5) detecting the return of the said infrared radiation after the said infrared radiation has been reflected by the said second object (2);
the said receiver (5) being affixed to the said first object (1) close to the said emitter (4) and producing an electrical signal of reception; the said device being characterized in that it includes:
1/means of control (8) of the said electrical signal enabling the gradual variation of the power of the infrared radiation emitted by the said emitter (4), by controlling the said electrical emission signal until the power of the infrared radiation emitted attains a power of detection (PS) such that, for this power of detection (PS) the infrared radiation is detected by the said receiver (5) after reflection by the said second object (2),
2/means for calculation (9) of the distance (D) between the said first object (1) and the said second object (2), setting out from the value of the said detection power (PS), utilizing correlations previously established particularly by calibration, between the said distance (D) and the said detection power (PS).

10. Device according to claim 9, the said device being such that:
the said emitter (4) includes an electroluminescent diode emitting specifically at a given infrared wavelength,
the said receiver (5) includes a phototransistor or photodiode detecting specifically the said given infrared wavelength.

11. Device according to either one of claims 9 or 10, the said means of control (8) of the said electrical signal permitting the gradual variation of the power of the infrared radiation emitted by the said emitter (4), containing a first processor (8) controlling the said electrical emission signal such that the said infrared radiation is emitted in a specific mode containing a signature.

12. Device according to claim 11, the said first processor (8) being programmed such that the specific mode of emission of the said emitter (4) is a pulsed mode of emission having a given pulsation frequency characterizing the said signature.

13. Device according to either one of claims 11 or 12, the said first processor (8) controlling the said electrical emission signal being programmed such that the specific mode of emission of said emitter (4) is a pulsed mode of emission containing a digital signature.

14. Device according to claim 13, the said first processor (8) being programmed such that the said electrical emission signal is a square-wave signal and that the said digital signature of the said infrared radiation appears in the form of a logical signal composed of (“1”) or (“0”) according to whether the emitter is or is not fed the said square-wave signal.

15. Device according to any one of claims 11 to 14, the said device being such that, to determine whether a reflected infrared ray received by a receiver (5) from a particular object (1) originates from an emitter (4) situated on the said determinate object, the said first processor (8) contains means of verification of the said signature, so that it is possible to discriminate between the reflected infrared radiation coming from the emitter (4) of the said determinate object (1) and the infrared rays originating directly or indirectly from other objects.

16. Device according to claim 15, the said means of verification of the said signature containing means for comparing the electric signal supply signal of the emitter (4) of the said determinate object (1) with the electric signal given by the receiver (5) from the same said determinate object (1).

17. Device according to anyone of claims 11 to 16, the said device being such that:
by a digital signal on n bits, the said first processor (8) controls through field effect transistors n resistances of different values mounted on the electric power supply of the said emitter (4) such that the power of the infrared radiation emitted by the said emitter (4), particularly by an electroluminescent diode, can assume 2ⁿ increasing values,
the said first processor (8), connected to the receiver (5), verifies that the electrical signal given by the receiver (5) contains the same signature, particularly the said digital signal,
the said first processor (8) transmits to a second processor (9) a signal formed on n bits indicating, among the 2ⁿ possible values of the said detection power (PS), the one which it has found,
the said second processor (9) computes the distance between the first object (1) and the second object (2) by correlation from a calibration of the 2ⁿ possible values of distance in relation to the 2ⁿ detection power values.

18. Device according to claim 17, the said device being such that the said emitter (4), particularly an emitting diode, is capable of emitting a given maximum radiation power P1 and the said receiver (5), particularly a receiving diode, is capable of detecting a given minimum radiation power P2, the values of P1 being such that it is possible to measure distances between 0.5 m and 5 m, and more preferably between 0.1 m and 10 m.

19. Device according to either of claims 17 or 18, the number of detection power steps and the number n of resistances of different values Ri with i=t to n being such that the precision of measurement, consisting in the separation between the said 2ⁿ possible consecutive distances it at least 10 cm, preferably at least 1 cm.

20. Device according to any one of claims 9 to 17, the said device being furthermore more particularly designed to determine the position of one or more second objects (2) with respect to a frame of reference bound to the said first object (1), the said device furthermore including:
a plurality of emitters (4) and receivers (5) emitting and receiving infrared rays in a plurality of directions distributed in an appropriate manner around the said first object (1), preferably in at least four directions, and more preferably in at least eight directions,
said infrared rays associated with each direction being emitted in cones whose apex angle is between 5 and 90°,
such that the said second objects (2) situated in the vicinity of the said first object (1) are detected and their positions with respect to a frame of reference connected with the first object (1) can be calculated.

21. Mobile robot detecting and avoiding obstacles, the said mobile robot containing means of displacement controlled by a control means including a device according to any one of claims 9 to 20, such that:
if one or more obstacles are in the vicinity of the said mobile robot,
if the said mobile robot moves in a direction coinciding with that in which the said obstacle is situated,
if the distance measured between the said mobile robot and the said obstacle is below a particular value, particularly in relation to the speed of movement of the said mobile robot,
the said device programs a change of path while taking into account other obstacles situated in the vicinity.

22. Application of the method and of the device according to any one of claims 1 to 20 to the detection and to the avoidance of an obstacle by a vehicle, particularly a robot:
the said vehicle corresponding to the said first object (1),
the said obstacle corresponding to the said second object (2),
such that:
if one or more obstacles are in the vicinity of the said vehicle,
if the said vehicle moves in a direction coinciding with the one in which the said obstacle is situated,
if the distance measured between the said vehicle and the said obstacle is less than a determinate value, particularly according to the speed of movement of the said vehicle,
the said vehicle programs a change of course, taking into account other obstacles situated in the vicinity.

23. Vehicle (1), characterized in that it includes:
at least two infrared pickups fixedly mounted on the said vehicle, each pickup containing an emitter able to emit infrared radiation in a first portion of the space surrounding the vehicle, and containing a receiver sensitive to any infrared radiation received from a second portion of the space surrounding the vehicle,
electronic means (8) of control of the power fed to the emitter, adapted to vary, regularly and cyclically, the power of the current supplied to the emitter so as to bring about a step-by-step increase of the radiation emitted by the emitter of each pickup,
electronic means (9) for detection of an obstacle and/or for measurement of a distance (D) separating the vehicle from an object (2), setting out on the one hand from signals delivered by the said receivers from the said pickups, and on the other hand from signals or data delivered by the said electronic means (8) for controlling the power supplied to the emitter of the pickups.

24. Vehicle according to claim 21 or 23 which contains:
a common line for supplying a plurality of said infrared emitters,
a plurality of branches inserted into the said common supply line, each branch having a resistor (R1 to R4) and containing a switch (Q1 to Q4), the said branches being connected in parallel,
means (8) adapted to deliver to the switches (Q1 to Q4) an opening or closing digital command, such as to cause the current delivered to the emitters to vary.
